(19) United States
(12) Patent Application Publication
(10) Pub. No.: US 2017/0005449 A1
(43) Pub. Date: Jan. 5, 2017

(54) METHOD FOR MOUNTING A MULTIPLE-CONTACT PRESS-FIT CONNECTOR

(71) Applicant: SOURIAU, VERSAILLES (FR)

(72) Inventor: PASCAL RIBEAU, LE MANS (FR)

(21) Appl. No.: 15/192,004

(22) Filed: Jun. 24, 2016

(30) Foreign Application Priority Data
Jun. 30, 2015 (FR) 15 56168

(51) Int. Cl. H01R 43/20; H01R 13/05; H01R 12/58

(52) U.S. Cl. CPC H01R 43/205; H01R 12/585; H01R 13/052

(57) ABSTRACT

A method for mounting a multiple-contact press-fit connector. A press-fit contact is positioned above four metallized bores made in a printed circuit board. The printed circuit board includes a printed circuit corresponding to the dimensions of the four pins of the press-fit contact. The press-fit contact is installed by a predetermined pressure from an insert on a flange of the press-fit contact. The method repeats these steps of positioning and installing the press-fit contact.

### TECHNICAL FIELD OF THE INVENTION

This invention relates to a method for mounting a multiple-contact press-fit connector assembly. It applies to an assembly of press-fit connectors, each of which has four contacts, commonly known as “quadrax” contacts.

### STATE OF THE ART

Known examples of quadrax contacts are defined by the standard ARINC 600 and have a generally cylindrical shape.

Current quadrax contacts are designed to be soldered to printed circuit boards. One alternative for replacing soldering consists in using press-fit (registered trademark) contact pins. These press-fit contacts are known in the prior art. Said contacts are commonly used to make solderless connections on a printed circuit board.

The mounting of press-fit contact pins is suitable for connecting a printed circuit board to an electrical device.

Press-fit connection is made when a pin is pressed into a metallized transverse hole of the right size located on a printed circuit board.

The use of this technology requires insertion force of about 100N in order to assemble the press-fit contact on a printed circuit board. With such force, the pins of the contact are liable to be deformed by buckling. Similarly, that insertion force leads to the risk of damaging the board. That results in mounting scraps during production.

OBJECT OF THE INVENTION

The invention is aimed at remedying those drawbacks.

To that end, in a first aspect, the invention relates to a method for mounting a multiple-contact press-fit connector. Said method comprises the steps of:
a) positioning a press-fit contact above four metallized bores made in a printed circuit board comprising a printed circuit corresponding to the dimensions of the four pins of the press-fit contact,
b) installing the press-fit contact by predetermined pressure from an insert on a flange of the press-fit contact,
c) wherein the method comprises a repetition of steps (a) and (b).

The predetermined pressure is approximately 100 to 200N (approximately 40N per contact, and there are four contacts).

Mounting each press-fit contact one by one on the printed circuit board avoids applying pressure on a press-fit contact assembly and avoids leading to buckling in the pins. Further, mounting each press-fit contact one by one on the printed circuit board also avoids damaging said printed circuit board, as the insertion force is reduced to that corresponding to a single contact.

In one embodiment, the method according to the invention comprises a repetition of steps (a) and (b).

Thus, the method makes it possible to achieve an intermediate result and propose eleven quadrax contacts positioned in relation to each other, ready to receive a rectangular piece in the subsequent step.

In one embodiment, the method further comprises a step of covering the press-fit contacts by an insert with a rectangular shape comprising through bores to cover said press-fit contacts.

Thus, the method makes it possible to make a multiple-contact connector with eleven quadrax contacts with a rectangular shape.

In one embodiment, the method comprises a step of inserting the insert with a rectangular shape in the printed circuit board via pins.

Thus, the pins of the insert are connected by the pins to the printed circuit board. The printed circuit board comprising a printed circuit makes it possible to connect the assembly to the ground.

In one embodiment, the method comprises a step of connecting a contact body to the printed circuit board through the pins for grounding, wherein said contact body is tightly fitted in the insert.

Thus, all the components are connected to the ground.

### BRIEF DESCRIPTION OF FIGURES

Other advantages, aims and characteristics of this invention will become apparent in the description below, which is explanatory and not limitative in any way, by reference to the drawings attached, wherein:

FIG. 1 is a perspective view of several press-fit contacts,

FIGS. 2 to 5 represent the assembly steps of a multiple-contact connector,

FIG. 6 is a logical diagram of the steps used in a particular embodiment of the method according to this invention.

### DESCRIPTION OF EXEMPLARY EMBODIMENTS OF THE INVENTION

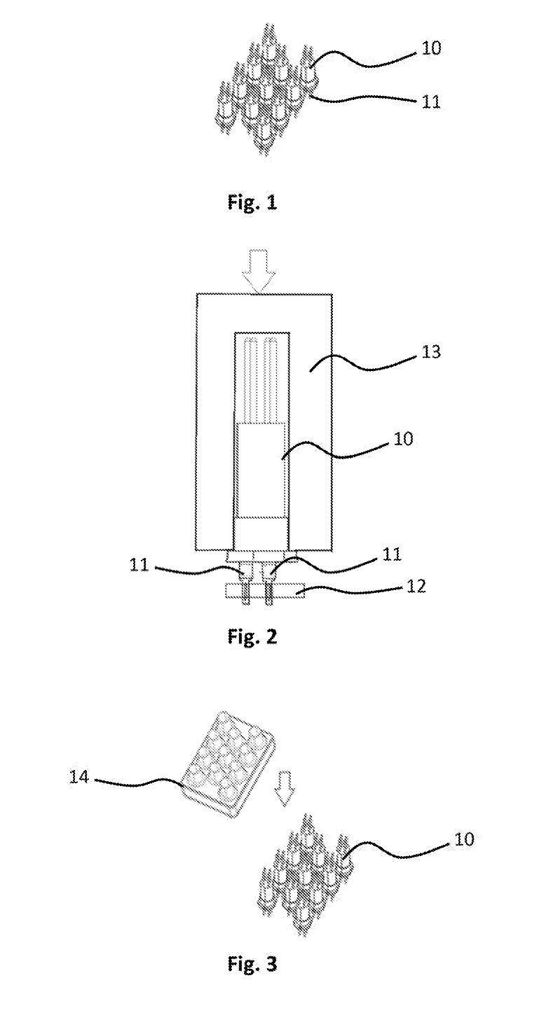

FIG. 1 shows press-fit contacts 10. These contacts have a flange to allow the mounting of the four pins 11.

The method according to this invention consists in inserting each press-fit contact on a printed circuit board 12 with a printed circuit.

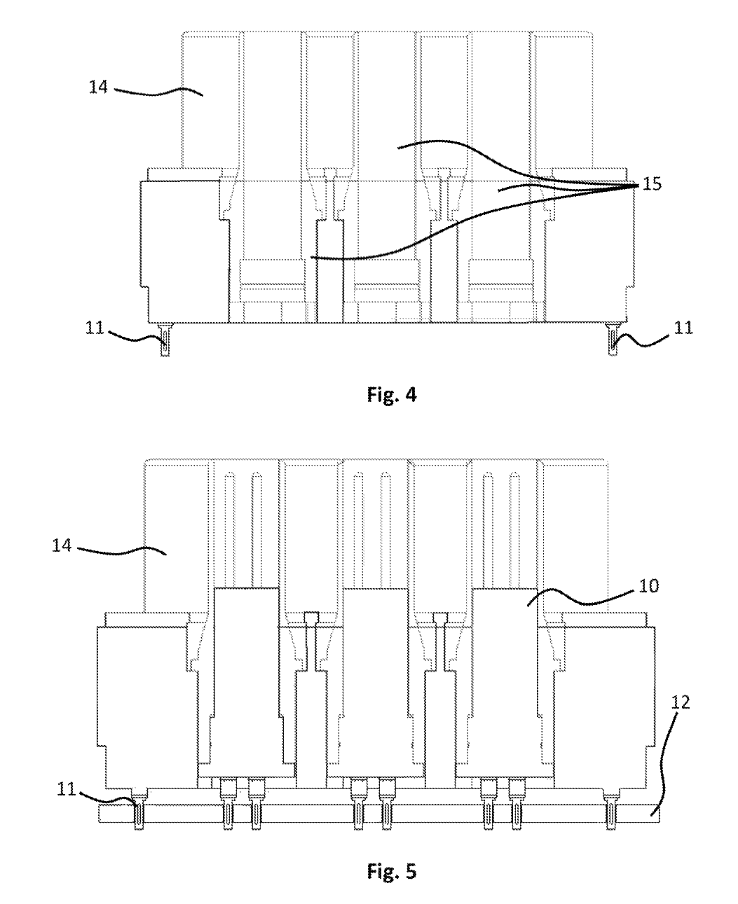

FIG. 2 shows the step of mounting each press-fit contact on the printed circuit board 12. The four pins 11 are inserted on the printed circuit board 12 by an insert 13. The insert 13 is circular in shape and surrounds the press-fit contact 10. The insert 13 is supported by the flange when it covers the press-fit contact 10. The pressure applied on the flange of the press-fit contact 10 makes it possible to push the four pins of the press-fit contact 10 into the printed circuit board 12. The insertion force is approximately 100 to 200N.

FIG. 3 shows the mounting of an insert with a rectangular shape 14 on the press-fit contacts 10 and in the printed circuit board (not shown).

Covering the contacts that have first been mounted on the printed circuit board does not apply stress on the board, since the rectangular insert 14 only has four pins like a press-fit contact. The insertion force is thus the same.

FIG. 4 shows an insert with a rectangular shape 14 on its own. The rectangular insert 14 has four pins 11 (only two pins 11 are shown in this figure).

The insert with a rectangular shape 14 comprises metal contact bodies 15 that are adapted to be fitted tightly in the mechanical parts of the rectangular insert 14. The rectangular insert 14 is in metal and ground bonding is achieved by means of pins 11.

FIG. 5 shows the mounting of a multiple-contact connector comprising the insert with a rectangular shape 14 with the printed circuit board 12 comprising a printed circuit, pins 11 and press-fit contacts 10.

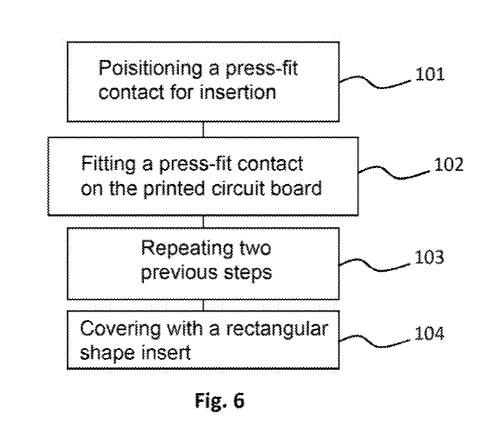

FIG. 6 shows the steps for manufacturing a multiple-contact connector according to this invention, which comprises:
a step 101 in which a press-fit contact 10 is positioned above four bores in a printed circuit board 12,
a step 102 in which a press-fit contact 10 is fitted on the printed circuit board 12,
a step 103 in which the two steps 101 and 102 are repeated to repeat the fitting of several press-fit contacts 10 without applying high pressure on the press-fit contact 10 or the printed circuit board 12,
a step 104 in which the assembly made in the previous steps is covered by an insert with a rectangular shape.

During step 104, the insert with a rectangular shape 14 covers the press-fit contacts 10. The insert with a rectangular shape 14 acts as the standard interface with existing connectors.

### LIST OF PARTS

10 press-fit contact

11 pin

12 printed circuit board

13 insert

14 rectangular insert

15 contact body

1-5. (canceled)

6. A method for mounting a multiple-contact press-fit connector, comprising the steps of:
a) positioning a press-fit contact above four metallized bores made in a printed circuit board comprising a printed circuit corresponding to dimensions of four pins of the press-fit contact;
b) installing the press-fit contact by a predetermined pressure from an insert on a flange of the press-fit contact; and
c) repeating the steps (a) and (b).

7. The method according to claim 6, wherein the repeating step repeats eleven times the steps (a) and (b).

8. The method according to claim 6, further comprising the step of covering the press-fit contacts by an insert with a rectangular shape comprising through bores to cover the press-fit contacts.

9. The method according to claim 8, further comprising the step of inserting the insert with the rectangular shape in the printed circuit board via the pins.

10. The method according to claim 8, further comprising the step of connecting a contact body to the printed circuit board through the pins for grounding, wherein said contact body is tightly fitted in the insert.
